(19) United States
(12) Patent Application Publication
(10) Pub. No.: US 2026/0205396 A1
(43) Pub. Date: Jul. 16, 2026

(54) OPTICAL LINE TERMINAL AND ROUND-TRIP TIME ADJUSTMENT METHOD THEREOF

(71) Applicant: REALTEK SINGAPORE PRIVATE LIMITED, SINGAPORE (SG)

(72) Inventors: Tao Guo, Shanghai (CN); Donggun Keung, Milpitas, CA (US)

(21) Appl. No.: 19/015,940

(22) Filed: Jan. 10, 2025

(51) Int. Cl. H04L 43/0864; H04B 10/077; H04B 10/69

(52) U.S. Cl. CPC H04L 43/0864; H04B 10/0773; H04B 10/6932

(57) ABSTRACT

An optical line terminal (OLT) and a round-trip time adjustment method of the OLT are disclosed, and the adjustment method includes: transmitting a downstream message to at least one of optical network units (ONUs); receiving an upstream message from one of the ONUs; calculating a reference round-trip time according to a first time point at which the OLT transmits the downstream message and a second time point at which the OLT receives the upstream message; calculating a time difference between the reference round-trip time and an original round-trip time of the ONU that responds to the OLT with the upstream message; adjusting the original round-trip times to updated round-trip times respectively according to the time difference; and performing data transmission between the OLT and the ONUs via the second network port according to the updated round-trip times.

### FIELD OF THE DISCLOSURE

The present disclosure relates to a network system, and more particularly to an optical line terminal and a round-trip time adjustment method thereof.

### BACKGROUND OF THE DISCLOSURE

In order to prevent data transmission between the optical line terminal and a plurality of optical network units from stopping due to fiber damage, a default fiber and a backup fiber are usually mounted between the optical line terminal and the plurality of optical network units. When the default fiber that is initially responsible for data transmission is damaged, the data transmission work is switched from the default fiber to the backup fiber.

The downstream message that is transmitted to each of the optical network units from the optical line terminal includes an upload start time for each of optical network units, and the upload start time is calculated based on the round-trip time point of each of the optical network units on the default fiber.

However, the upload start time of the downstream message can be incorrect when the length of the backup fiber differs from the length of the default fiber, which can lead to data collision of multiple upload data from the optical network units.

### SUMMARY OF THE DISCLOSURE

In response to the above-referenced technical inadequacy, the present disclosure provides an optical line terminal and a round-trip time adjustment method of the optical line terminal.

In order to solve the above-mentioned problem, one of the technical aspects adopted by the present disclosure is to provide an optical line terminal (OLT). The OLT is applied to a passive optical network (PON) system including a plurality of optical network units (ONUs). The OLT includes a first network port being coupled to the ONUs and a second network port being connected to the ONUs. The OLT stores a plurality of original round-trip times for transmission between the OLT and the ONUs via the first network port. In response to an abnormality in the transmission via the first network port, the OLT performs the following operations: transmitting at least one downstream message to at least one of the ONUs via the second network port; receiving an upstream message from one of the at least one of the ONUs via the second network port; calculating a reference round-trip time according to a first time point at which the OLT transmits the downstream message and a second time point at which the OLT receives the upstream message; calculating a time difference between the reference round-trip time and the original round-trip time of the ONU that responds to the OLT with the upstream message; adjusting the original round-trip times to a plurality of updated round-trip times respectively according to the time difference; and performing transmission between the OLT and the ONUs via the second network port according to the updated round-trip times.

In order to solve the above-mentioned problem, another one of the technical aspects adopted by the present disclosure is to provide a round-trip time adjustment method of an optical line terminal (OLT). The OLT includes a first network port and a second network port and stores a plurality of original round-trip times for transmission between the OLT and a plurality of optical network units (ONUs) via the first network port. The round-trip time adjustment method includes: in response to an abnormality in the transmission via the first network port, the OLT performs the following steps: transmitting at least one downstream message to at least one of the ONUs via the second network port; receiving an upstream message from one of the at least one of the ONUs via the second network port; calculating a reference round-trip time according to a first time point at which the OLT transmits the downstream message and a second time point at which the OLT receives the upstream message; calculating a time difference between the reference round-trip time and the original round-trip time of the ONU that responds to the OLT with the upstream message; adjusting the original round-trip times to a plurality of updated round-trip times respectively according to the time difference; and performing transmission between the OLT and the ONUs via the second network port according to the updated round-trip times.

Therefore, in the optical line terminal and the round-trip time adjustment method of the optical line terminal provided by the present disclosure, when the abnormality occurs in the transmission between the first network port and the ONUs, the second network port can transmit data to the ONUs in a short time period according to the updated round-trip times.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of an optical line terminal applied to a passive optical network system according to one embodiment of the present disclosure;

FIG. 2 is a schematic diagram of the optical line terminal according to one embodiment of the present disclosure;

FIG. 3 is a flowchart of a first stage of a round-trip time adjustment method of the optical line terminal according to one embodiment of the present disclosure;

FIG. 4 is a flowchart of a second stage of the round-trip time adjustment method of the optical line terminal according to one embodiment of the present disclosure; and

FIG. 5 is a flowchart of a third stage of the round-trip time adjustment method of the optical line terminal according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

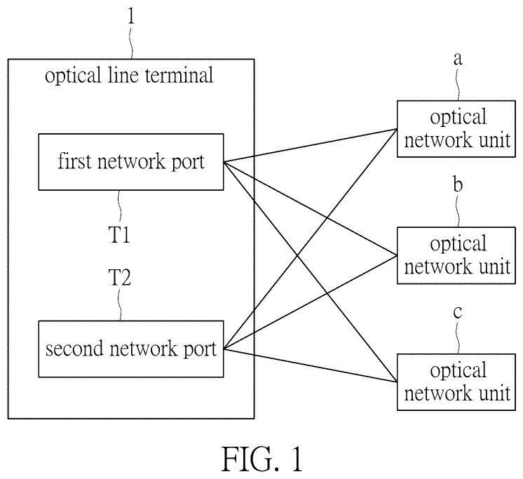

FIG. 1 is a schematic diagram of an optical line terminal applied to a passive optical network system according to one embodiment of the present disclosure. Referring to FIG. 1, the optical line terminal (OLT) 1 includes a first network port T1 and a second network port T2, and the passive optical network (PON) system includes a plurality of optical network units (ONUs) a, b, c. The first network port T1 is connected to the ONUs a, b, c. The second network port T2 is connected to the ONUs a, b, c. The OLT 1 stores a plurality of original round-trip times for transmission between the OLT 1 and ONUs a, b, c via the first network port T1. The number of ONUs in the above PON system is an example, and the present disclosure is not limited thereto.

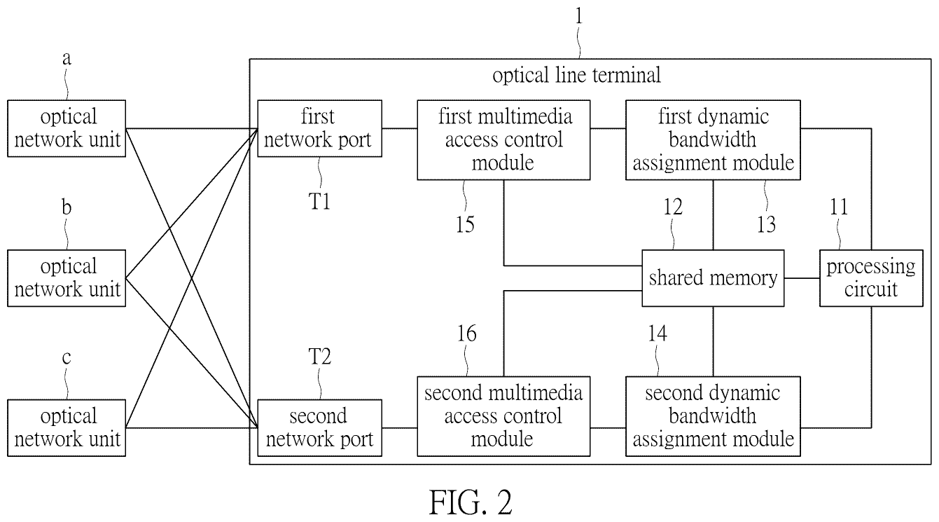

FIG. 2 is a schematic diagram of the OLT according to one embodiment of the present disclosure. Referring to FIG. 1 and FIG. 2, the OLT 1 also includes a processing circuit 11, a shared memory 12, a first dynamic bandwidth assignment module 13, a second dynamic bandwidth assignment module 14, a first multimedia access control module 15 and a second multimedia access control module 16.

The processing circuit 11 is, for example, a system-on-chip circuit. The shared memory 12 is, for example, a programmable read-only memory (PROM), an erasable programmable read-only memory (EPROM) or a flash memory.

The first dynamic bandwidth assignment module 13, the second dynamic bandwidth assignment module 14, the first multimedia access control module 15 and the second multimedia access control module 16 are, for example, hardware, software or firmware that are executed on the hardware.

The first dynamic bandwidth assignment module 13 and the second dynamic bandwidth assignment module 14 are configured to adjust a bandwidth between the OLT 1 and each of the ONUs a, b, c, an upload start time of each of the ONUs a, b, c, and an upload volume of each of the ONUs a, b, c according to network traffic conditions between the OLT 1 and each of the ONUs a, b, c.

The first multimedia access control module 15 and the second multimedia access control module 16 are configured to define a control mechanism between the OLT 1 and the ONUs a, b, c to coordinate data transmitting and receiving efficiently.

The processing circuit 11 is connected to the shared memory 12 and communicates with the first dynamic bandwidth assignment module 13 and the second dynamic bandwidth assignment module 14.

The shared memory 12 communicates with the first dynamic bandwidth assignment module 13, the second dynamic bandwidth assignment module 14, the first multimedia access control module 15 and the second multimedia access control module 16. The shared memory 12 stores a plurality of original round-trip times for transmission between the OLT 1 and the ONUs a, b, c via the first network port T1.

The first dynamic bandwidth assignment module 13 and the second dynamic bandwidth assignment module 14 communicate with the first multimedia access control module 15 and the second multimedia access control module 16, respectively.

The first multimedia access control module 15 and the second multimedia access control module 16 communicate with the first network port T1 and the second network port T2, respectively.

First, the OLT 1 is initialized to establish an inter-process communication between the processing circuit 11 and the first dynamic bandwidth assignment module 13 and establish an inter-process communication between the processing circuit 11 and the second dynamic bandwidth assignment module 14.

After the initialization of the OLT 1 is completed, the OLT 1 performs the transmission between the OLT 1 and the ONUs via the first network port T1.

When the OLT 1 performs the transmission between the OLT 1 and the ONUs a, b, c via the first network port T1, the first dynamic bandwidth assignment module 13 and the second dynamic bandwidth assignment module 14 are in an active mode and a standby mode, respectively, and the first multimedia access control module 15 and the second multimedia access control module 16 are in the active mode and the standby mode, respectively.

First, the first dynamic bandwidth assignment module 13 obtains the original round-trip times for the transmission between the OLT 1 and the ONUs a, b, c via the first network port T1 from the shared memory 12.

Regarding the acquisition of the original round-trip times in the shared memory 12, specifically, the OLT 1 first transmits a downstream message to the ONU a through the first network port T1 and records a time point at which the OLT 1 transmits the downstream message to the ONU a. When the OLT 1 receives an upstream message from the ONU a, the OLT 1 records a time point at which the OLT 1 receives the upstream message from the ONU a. The OLT 1 calculates a time difference between the time point at which the OLT 1 transmits the downstream message to the ONU a and the time point at which the OLT 1 receives the upstream message from the ONU a to obtain the original round-trip time for transmission between the OLT 1 and the ONU a via the first network port T1.

After the OLT 1 obtains the original round-trip time for the transmission between OLT 1 and the ONU a via the first network port T1, the OLT 1 transmits a downstream message to the ONU b via the first network port T1 and records a time point at which the OLT 1 transmits the downstream message to the ONU b. When the OLT 1 receives an upstream message from the ONU b, the OLT 1 records a time point at which OLT 1 receives the upstream message from the ONU b. The OLT 1 calculates a time difference between the time point at which OLT 1 receives the upstream message from the ONU b and the time point the OLT 1 transmits the downstream message to the ONU b to obtain the original round-trip time for transmission between the OLT 1 and the ONU b via the first network port T1.

After the OLT 1 obtains the original round-trip time for the transmission between the OLT 1 and the ONU b via the first network port T1, the OLT 1 transmits a downstream message to the ONU c via the first network port T1 and records a time point at which the OLT 1 transmits a downstream message to the ONU c. When the OLT 1 receives an upstream message from the ONU c, the OLT 1 records a time point at which the OLT 1 receives the upstream message from the ONU c. The OLT 1 calculates a time difference between the time point at which the OLT 1 receives the upstream message from the ONU c and the time point at which the OLT 1 transmits the downstream message to the ONU c to obtain the original round-trip time for transmission between OLT 1 and the ONU c via the first network port T1.

Then, the first dynamic bandwidth assignment module 13 calculates an upload start time of the ONU a and an upload volume of the ONU a according to the original round-trip time for the transmission between the OLT 1 and the ONU a via the first network port T1. The upload start time of the ONU a is a start time point at which the OLT 1 allows the ONU a to upload data to the OLT 1.

The first dynamic bandwidth assignment module 13 calculates an upload start time of the ONU b and an upload volume of the ONU b according to the original round-trip time for the transmission between the OLT 1 and the ONU b via the first network port T1.

The first dynamic bandwidth assignment module 13 calculates an upload start time of the ONU c and an upload volume of the ONU c according to the original round-trip time for the transmission between the OLT 1 and the ONU c via the first network port T1.

Then, the first dynamic bandwidth assignment module 13 instructs the first multimedia access control module 15 to respectively transmit a plurality of downstream messages to the ONU a, b, c via the first network port T1. Specifically, the downstream message transmitted to the ONU a by the first network port T1 includes the upload start time of the ONU a, the upload volume of the ONU a, and identification information of the ONU a. The downstream message transmitted to the ONU b by the first network port T1 includes the upload start time of the ONU b, the upload volume of the ONU b, and identification information of the ONU b. The downstream message transmitted to the ONU c by the first network port T1 includes the upload start time of the ONU c, the upload volume the ONU c, and identification information of the ONU c.

When an abnormality occurs in the transmission between the first network port T1 and the ONUs a, b, c, for example, an optical fiber between the first network port T1 and the ONU a is broken, the OLT 1 stops transmitting data to the ONUs a, b, c via the first network port T1, and OLT 1 transmit data to the ONUs a, b, c via the second network port T2 and receive data from the ONUs a, b, c via the second network port T2.

Specifically, the processing circuit 11 switches the first dynamic bandwidth assignment module 13 from the active mode to the standby mode, and switches the second dynamic bandwidth assignment module 14 from the standby mode to the active mode. The processing circuit 11 switches the multimedia access control module 15 from the active mode to the standby mode, and switches the second multimedia access control module 16 from the standby mode to the active mode.

Then, the second dynamic bandwidth assignment module 14 in the active mode obtains a plurality of updated round-trip times for the transmission between the OLT 1 and the ONUs a, b, c via the second network port T2 from the shared memory 12. The second dynamic bandwidth assignment module 14 calculates an updated upload start time of the ONU a and an updated upload volume of the ONU a according to the updated round-trip time for the transmission between the OLT 1 and the ONU a via the second network port T2.

The second dynamic bandwidth assignment module 14 calculates an updated upload start time of the ONU b and an update upload volume of the ONU b according to the updated round-trip time for the transmission between the OLT 1 and the ONU b via the second network port T2.

The second dynamic bandwidth assignment module 14 calculates an updated upload start time of the ONU c and an updated upload volume of the ONU c according to the updated round-trip time for the transmission between OLT 1 and the ONU c via the second network port T2.

Then, the second dynamic bandwidth assignment module 14 instructs the second multimedia access control module 16 to respectively transmit a plurality of updated downstream messages to the ONUs a, b, c via the second network port T2. Specifically, the downstream message transmitted by the second port T2 to the ONU a includes an updated upload start time of the ONU a, an updated upload volume of the ONU a and identification information of the ONU a. The downstream message transmitted by the second network port T2 to the optical network unit b includes an updated upload start time of the ONU b, an updated upload volume of the ONU b and identification information of the ONU b. The downstream message transmitted by the second network port T2 to the ONU c includes an updated upload start time of the ONU c, an updated upload volume of the ONU c and identification information of the ONU c.

How the updated round-trip times for the transmission between the OLT 1 and the ONUs a, b, c via the second network port T2 are generated will be described in sequence later.

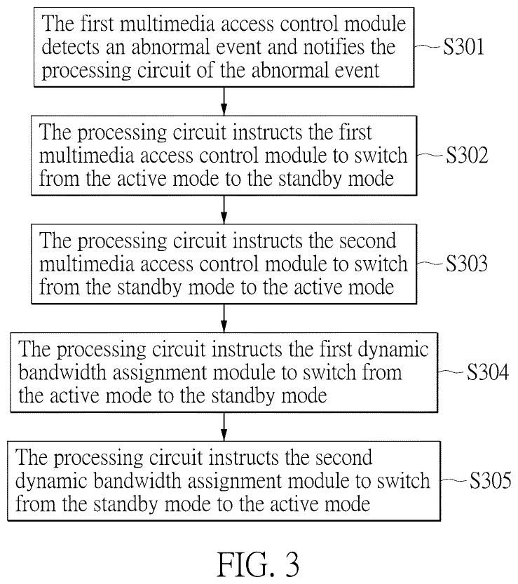

FIG. 3 is a flowchart of a first stage of a round-trip time adjustment method of the OLT according to one embodiment of the present disclosure. Referring to FIG. 2 and FIG. 3, in step S301, the first multimedia access control module 15 detects an abnormal event and notifies the processing circuit 11 of the abnormal event. In step S302, the processing circuit 11 instructs the first multimedia access control module 15 to switch from the active mode to the standby mode. In step S303, the processing circuit 11 instructs the second multimedia access control module 16 to switch from the standby mode to the active mode.

In step S304, the processing circuit 11 instructs the first dynamic bandwidth assignment module 13 to switch from the active mode to the standby mode. In step S305, the processing circuit 11 instructs the second dynamic bandwidth assignment module 14 to switch from the standby mode to the active mode.

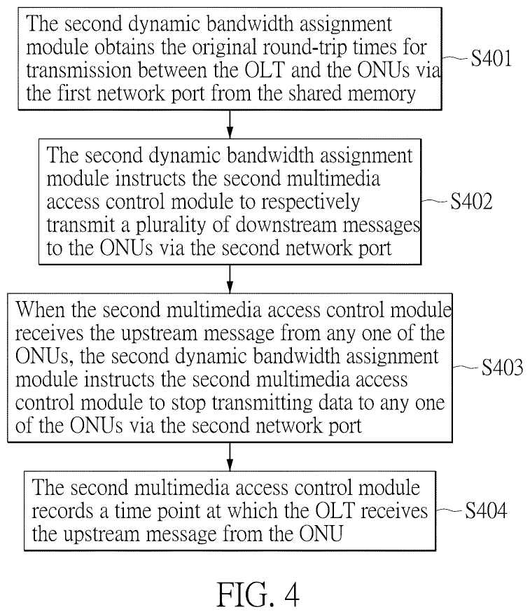

FIG. 4 is a flowchart of a second stage of the round-trip time adjustment method of the OLT according to one embodiment of the present disclosure. Referring to FIG. 2 and FIG. 4, in step S401, the second dynamic bandwidth assignment module 14 obtains the original round-trip times for transmission between the OLT 1 and the ONUs a, b, c via the first network port T1 from the shared memory 12. In step S402, the second dynamic bandwidth assignment module 14 instructs the second multimedia access control module 16 to respectively transmit a plurality of downstream messages to the ONUs a, b, c via the second network port T2.

Specifically, the downstream message transmitted to the ONU a by the second network port T2 includes an upload start time of the ONU a, an upload volume of the ONU a and identification information of the ONU a. The downstream message transmitted to the ONU b by the second network port T2 includes an upload start time of the ONU b, an upload volume of the ONU b and identification information of the ONU b. The downstream message transmitted to the ONU c by the second network port T2 includes an upload start time of the ONU c, an upload volume of the ONU c and identification information of the ONU c.

In step S403, when the second multimedia access control module 16 receives the upstream message from any one of the ONUs a, b, c, the second dynamic bandwidth assignment module 14 instructs the second multimedia access control module 16 to stop transmitting data to any one of the ONUs a, b, c via the second network port T2.

For example, among the ONUs a, b, c, the ONU a first receives the downstream message from the OLT 1. After the ONU a receives the downstream message, the ONU a responds to the OLT 1 with the upstream message. When the OLT 1 receives the upstream message from the ONU a, the second dynamic bandwidth assignment module 14 instructs the second multimedia access control module 16 to stop transmitting data to any one of the ONUs a, b, c via the second network port T2.

In step S404, the second multimedia access control module 16 records a time point at which the OLT 1 receives the upstream message from the ONU a.

In other embodiments, the second dynamic bandwidth assignment module 14 instructs the second multimedia access control module 16 to only transmit the downstream message to one of the ONUs a, b, c through the second network port T2.

For example, the second dynamic bandwidth assignment module 14 instructs the second multimedia access control module 16 to only transmit the downstream message to the ONU a through the second network port T2. After the ONU a receives the downstream message from the OLT 1, the ONU a responds to the OLT 1 with the upstream message. When the second multimedia access control module 16 receives the upstream message from the ONU a, the second dynamic bandwidth assignment module 14 instructs the second multimedia access control module 16 to stop transmitting data to any one of the ONUs a, b, c via the second network port T2.

Because the OLT 1 only transmits one downstream message to one of the ONUs, it only receives one upstream message such that the collision of multiple upstream messages can be prevented from occurring.

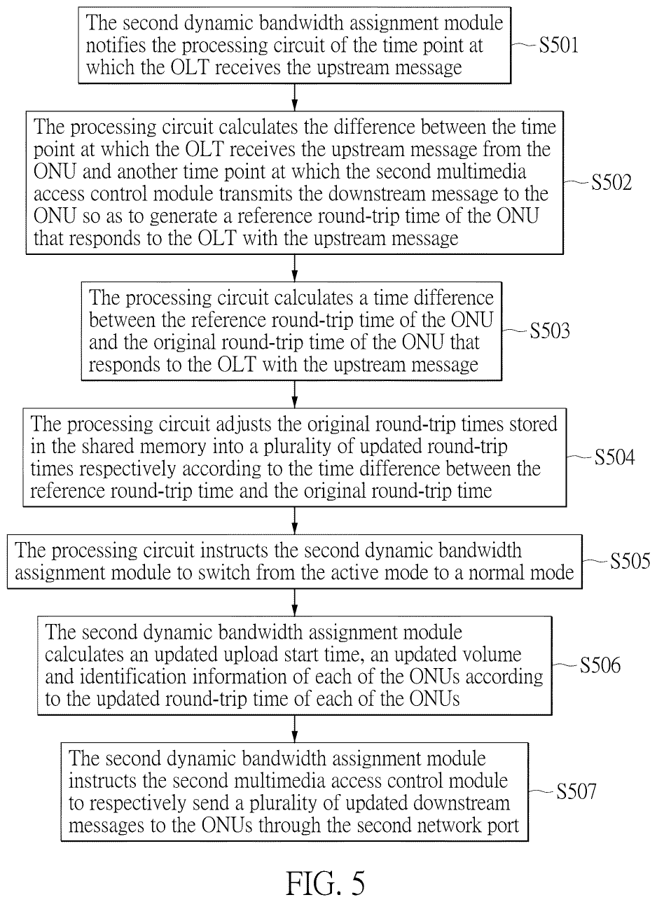

FIG. 5 is a flowchart of a third stage of the round-trip time adjustment method of the OLT according to one embodiment of the present disclosure.

Referring to FIG. 2 and FIG. 5, in step S501, the second dynamic bandwidth assignment module 14 notifies the processing circuit 11 of the time point at which the OLT 1 receives the upstream message.

In step S502, the processing circuit 11 calculates the difference between the time point at which the OLT 1 receives the upstream message from the ONU a and another time point at which the second multimedia access control module 16 transmits the downstream message to the ONU a so as to generate a reference round-trip time of the ONU a that responds to the OLT 1 with the upstream message.

In step S503, the processing circuit 11 calculates a time difference between the reference round-trip time of the ONU a and the original round-trip time of the ONU a that responds to the OLT 1 with the upstream message.

In step S504, the processing circuit 11 adjusts the original round-trip times stored in the shared memory 12 into a plurality of updated round-trip times respectively according to the time difference between the reference round-trip time and the original round-trip time.

In step S505, the processing circuit 11 instructs the second dynamic bandwidth assignment module 14 to switch from the active mode to a normal mode.

In step S506, the second dynamic bandwidth assignment module 14 calculates an updated upload start time, an updated volume and identification information of each of the ONUs according to the updated round-trip time of each of the ONUs.

In step S507, the second dynamic bandwidth assignment module 14 instructs the second multimedia access control module 16 to respectively send a plurality of updated downstream messages to the ONUs a, b, c through the second network port T2.

The updated downstream message sent from the second network port T2 to the ONU a includes an updated upload start time of the ONU a, an updated upload volume of the ONU a and identification information of the ONU a.

The updated downstream message sent from the second network port T2 to the ONU b includes an updated upload start time of the ONU b, an updated upload volume of the ONU b and identification information of the ONU b.

The updated downstream message sent from the second network port T2 to the ONU c includes an updated upload start time of the ONU c, an updated upload volume of the ONU c and identification information of the ONU c.

### BENEFICIAL EFFECTS OF THE EMBODIMENTS

In conclusion, in the optical line terminal and the round-trip time adjustment method of the optical line terminal provided by the present disclosure, when the abnormality occurs in the transmission between the first network port and the ONUs, the second network port of OLT can transmit data to the ONUs in a short time period according to the updated round-trip times.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical line terminal (OLT), applied to a passive optical network (PON) system comprising a plurality of optical network units (ONUs), the optical line terminal comprising:
a first network port being coupled to the ONUs;
a second network port being coupled to the ONUs ;
wherein the OLT stores a plurality of original round-trip times for transmission between the OLT and the ONUs via the first network port;
wherein, in response to an abnormality in the transmission via the first network port, the OLT performs the following operations:
transmitting at least one downstream message to at least one of the ONUs via the second network port;
receiving an upstream message from one of the at least one of the ONUs via the second network port;
calculating a reference round-trip time according to a first time point at which the OLT transmits the downstream message and a second time point at which the OLT receives the upstream message;
calculating a time difference between the reference round-trip time and the original round-trip time of the ONU that responds to the OLT with the upstream message;
adjusting the plurality of original round-trip times to a plurality of updated round-trip times respectively according to the time difference; and
performing transmission between the OLT and the ONUs via the second network port according to the updated round-trip times.

2. The OLT according to claim 1, wherein the OLT comprises a processing circuit, a shared memory, a first dynamic bandwidth assignment module and a second dynamic bandwidth assignment module, the shared memory communicates with the processing circuit, the first dynamic bandwidth assignment module and the second dynamic bandwidth assignment module, and the shared memory stores the original round-trip times.

3. The OLT according to claim 2, wherein, in response to the abnormality in the transmission via the first network port, the processing circuit instructs the first dynamic bandwidth assignment module to switch from an active mode to a standby mode, and instructs the second dynamic bandwidth assignment module to switch from the standby mode to the active mode.

4. The OLT according to claim 3, wherein the second dynamic bandwidth assignment module in the active mode obtains the plurality of original round-trip times from the shared memory.

5. The OLT according to claim 1, wherein the downstream message comprises an upload start time of the ONU.

6. The OLT according to claim 5, wherein, when the ONU receives the downstream message, the ONU responds to the second network port with the upstream message.

7. The OLT according to claim 6, wherein, when the second network port receives the upstream message, the OLT stops transmitting data to any one of the ONUs and records the second time point.

8. The optical line terminal according to claim 7, wherein the processing circuit adjusts the plurality of original round-trip times to the plurality of updated round-trip times according to the time difference and the shared memory stores the plurality of updated round-trip times corresponding to the second network port.

9. A round-trip time adjustment method of an optical line terminal (OLT), the OLT including a first network port and a second network port and storing a plurality of original round-trip times for transmission between the OLT and a plurality of optical network units (ONUs) via the first network port, the round-trip time adjustment method comprising:
in response to an abnormality in the transmission via the first network port, the OLT performs the following steps:
transmitting at least one downstream message to at least one of the ONUs via the second network port;
receiving an upstream message from one of the at least one of the ONUs via the second network port;
calculating a reference round-trip time according to a first time point at which the OLT transmits the downstream message and a second time point at which the OLT receives the upstream message;
calculating a time difference between the reference round-trip time and the original round-trip time of the ONU that responds to the OLT with the upstream message;
adjusting the original round-trip times to a plurality of updated round-trip times respectively according to the time difference; and
performing transmission between the OLT and the ONUs via the second network port according to the updated round-trip times.

10. The round-trip time adjustment method according to claim 9, wherein the OLT comprises a processing circuit, a shared memory, a first dynamic bandwidth assignment module and a second dynamic bandwidth assignment module, in response to the abnormality in the transmission via the first network port, the processing circuit instructs the first dynamic bandwidth assignment module to switch from an active mode to a standby mode and instructs the second dynamic bandwidth assignment module to switch from the standby mode switches to the active mode.

11. The round-trip time adjustment method according to claim 10, wherein the second dynamic bandwidth assignment module in the active mode obtains the plurality of original round-trip times from the shared memory.

12. The round-trip time adjustment method according to claim 10, wherein the downstream message comprises an upload start time of the ONU.

13. The round-trip time adjustment method according to claim 12, wherein, when the ONU receives the downstream message, the ONU responds to the second network port with the upstream message.

14. The round-trip time adjustment method according to claim 10, wherein, when the second network port receives the upstream message, the OLT stops transmitting data to any one of the ONUs and records the second time point.

15. The round-trip time adjustment method according to claim 10, wherein the processing circuit adjusts the plurality of original round-trip times to the plurality of updated round-trip times according to the time difference and the shared memory stores the plurality of updated round-trip times corresponding to the second network port.

16. The round-trip time adjustment method according to claim 9, wherein after the plurality of original round-trip times are respectively adjusted to the plurality of updated round-trip times, the OLT transmits a plurality of updated downstream messages via the second network port to the ONUs.
